(19) United States
(12) Patent Application Publication
(10) Pub. No.: US 2016/0357911 A1
(43) Pub. Date: Dec. 8, 2016

(54) COMPUTERIZED CLINICAL ACTION SYSTEM AND METHOD

(71) Applicant: Humana Inc, Louisville, KY (US)

(72) Inventors: Thadd Dillon, Louisville, KY (US); David Cardwell, Louisville, KY (US); Sadie Rizzuto, Louisville, KY (US); Chris Jones, Louisville, KY (US); Marsden Connolly, Louisville, KY (US)

(73) Assignee: Humana Inc, Louisville, KY (US)

(21) Appl. No.: 14/212,329

(22) Filed: Mar. 14, 2014

Related U.S. Application Data
(60) Provisional application No. 61/785,437, filed on Mar. 14, 2013.

(51) Int. Cl. G06F 19/00

(52) U.S. Cl. CPC G06F 19/322

(57) ABSTRACT

A computerized clinical action system and method supports a comprehensive view of member health status and identification of candidates for numerous clinical actions such as health alerts and clinical interventions. The computerized system and method facilitate clinical action integration and coordination by providing the infrastructure to share key member information among clinical actions. The computerized system and method comprises a clinical guidance exchange (CGX) that receives and accesses member data from a plurality of sources to facilitate creation of integrated member profiles. The CGX further receives and accesses clinical data from a clinical data hub that integrates clinical data from numerous sources. A rules guidance exchange (RGX) facilitates the identification of candidates for clinical actions through the application of clinical and business rules. The RGX assists in identifying the most appropriate actions for a member and routing communications to the member regarding the most appropriate actions.

### CROSS-REFERENCES TO RELATED APPLICATIONS

This application claims the benefit of U.S. Provisional Patent Application Ser. No. 61/785,437, filed Mar. 14, 2013, titled COMPUTERIZED CLINICAL ACTION SYSTEM AND METHOD, the contents of which is incorporated herein by reference.

### BACKGROUND

Many health benefit plan providers use clinical interventions for their plan members in an effort to support quality healthcare, improve clinical outcomes, and have a positive impact on the health and well-being of their membership. Participants of clinical intervention programs typically receive comprehensive educational and counseling services directed to management of a specific health condition. Clinical interventions are available for a wide array of health conditions and problems such as diabetes, chronic obstructive pulmonary disease, and cardiovascular disease as well as substance abuse, pharmacy, etc. Clinical intervention programs may be developed and administered by the health benefit provider or by third parties that contract with the health benefits provider to provide services to plan members.

Many clinical intervention programs are supported by software applications used by professionals to identify candidates for specific programs and to track members' progress in the programs .Although such software applications are very useful to the professionals that rely on them, they are typically designed to accept and analyze only a portion of a member's health and claim data in order to identify a specific health condition or problem that could be addressed in a clinical intervention. Because each software application and related candidate identification process is very specialized, health benefit providers do not have a comprehensive, collective approach to clinical interventions for all of their members. For health benefit providers that offer many clinical interventions and therefore, rely on many software applications and candidate identification processes, coordination that is necessary to provide a clear, comprehensive view of each member's health status is lacking.

Although formal clinical intervention programs involving ongoing education and counseling are important to health outcomes, less formal and more frequent communication between healthcare providers and members or their healthcare providers can also be beneficial to members and help to improve outcomes. For example, alerting healthcare providers of such events as a possible gap-in-care or a drug-on-drug interaction for a member can be an important element of a member's ongoing care. As is true for identifying candidates for clinical interventions, identifying appropriate alerts requires a comprehensive view of a member's health conditions as well as the clinical conditions warranting a clinical alert. Tracking of alerts and adherence to alerts is also an important aspect of care. However, candidate identification for alerts and other important communications is typically another independent activity that is not supported by a clear and comprehensive view of each member's health status.

Health benefit providers have a need for a computerized system and method that supports a comprehensive view of member health status so they can meet the needs of their member populations. Health benefit providers also have a need for a computerized system and method that supports a variety of clinical interactions with their member populations. Furthermore, employer groups and other organizations that sponsor health benefit plans for member populations are looking for a comprehensive clinical approach to numerous health conditions to control escalating costs and to better serve their plan beneficiaries. There is a need for a system and method that supports a comprehensive view of member health status and that assists in identifying candidates for clinical actions, clinical interventions, clinical alerts, clinical communications, and other numerous health programs and activities.

### SUMMARY

The present disclosure is directed to a computerized system and method that supports a comprehensive view of member health status and identification of candidates for clinical actions such as clinical interventions, clinical alerts, clinical communications, and other numerous health programs and activities. The computerized system and method supports a single process to identify clinical action candidates and eliminates the need to maintain multiple, independent candidate identification processes targeted to specific health conditions. The computerized system and method facilitate clinical action integration and coordination by providing the infrastructure to share key member information among clinical action opportunities. Processes for transferring and sharing information are HIPAA compliant to ensure member data is appropriately protected.

In an example embodiment, the computerized system and method comprises a clinical guidance exchange (CGX) that generates customized member profiles based on the needs of a diverse user community. The CGX receives and accesses member data from a plurality of sources to facilitate creation of integrated member profiles and to identify appropriate clinical actions. The CGX further receives and accesses clinical data from a clinical data hub that integrates clinical data from numerous sources. Member data and clinical data is analyzed and combined according to workflow requirements of the diverse user community to identify candidates for numerous clinical actions. The appropriate member information is directed to the right user base and allows those users to prioritize the work based on operational needs that may change daily.

In an example embodiment, the computerized system and method comprises a rules-based engine that facilitates the identification of candidates for clinical actions. The rules-based engine assists in identifying the most appropriate actions and interventions for a member and routing the member to the appropriate clinical activity. The integrated member profiles provide a complete view of member information that is important to the clinical process and identification of the appropriate clinical activity. A rules management process for the rules-based engine facilitates editing and updating of rules that are applied to member profile data to identify candidates. The computerized system and method further supports the exchange of information among clinical action identification processes so the appropriate information is considered in selecting members and routing them to clinical activities and interventions. The rules management process further supports the ability to exclude members based on plan, participation, and risk scores.

The computerized system and method supports the implementation of a comprehensive and coordinated clinical strategy for all members of a health benefits plan.

### BRIEF DESCRIPTION OF THE DRAWINGS

FIG. 1 is an architecture diagram for a computerized clinical action system and method according to an example embodiment;

FIG. 2 is a CGX workflow details diagram according to an example embodiment;

FIG. 3 is a data flow diagram for a CGX according to an example embodiment;

FIGS. 4A1, 4A2, 4B1, 4B2, and 4C illustrate rules processing by a RGX according to an example embodiment; and

FIG. 5 is a provider connectivity diagram according to an example embodiment.

### DETAILED DESCRIPTION

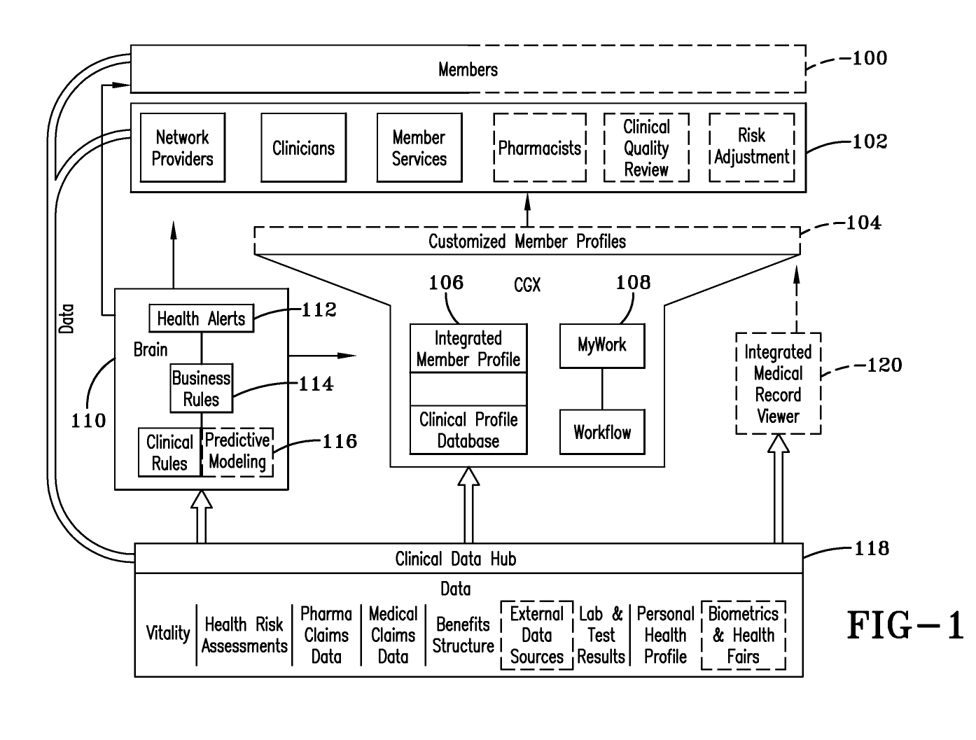

Referring to FIG. 1, an architecture diagram for a computerized clinical action system and method according to an example embodiment is shown. In an example embodiment, members of a health benefits plan receive communications regarding clinical actions that are appropriate for them based on their current health status and conditions 100. A clinical guidance exchange (CGX) 104 generates customized member profiles for a diverse user base that includes healthcare providers, health plan clinicians, health plan customer service representatives, pharmacists, client quality review associates, and risk adjustment associates 102. Data for customized member profiles is received from a clinical data hub 118 that receives and/or extracts data from a plurality of sources such as a personalized health program (e.g., Humana Vitality), health risk assessments, pharmacy claims data, medical claims data (e.g., paid, pended, and rejected claims), health benefits plan structure, laboratory and test results, a personal health profile, biometric and health fairs, and other external data sources. The clinical data hub 118 supports an integrated member profile 106 containing data for various clinical views of claims, laboratory, pharmacy and other medical data at the member level as well as plan and demographic data that is used in decisioning.

A rules guidance exchange (RGX) 110 comprises a plurality of rules-based processes such as a clinical rules/predictive modeling process 116 to facilitate identification, both proactive and retroactive, of a member's clinical and health conditions and a business rules process 114 to identify clinical actions that may be offered by a health plan sponsor and that may be appropriate for members of the sponsor's health plan. The RGX 110 provides clinical inference data containing the results of the clinical rules/predictive modeling process 116 executed against clinical member profile data. The RGX 110 then generates clinical actions (e.g., alerts or interventions) 112 to members and/or their caregivers, physicians and other healthcare providers, and clinicians 102. In an example embodiment, health alerts may comprise evidence-based medicine gap-in-care, HEDIS, drug-to-drug interaction, drug-to-disease interaction, medication possession ratios (medication adherence), and utilization analysis alerts. The alerts may be distributed to various portals (e.g., an eligibility and benefits web page for members and their caregivers, a care profile web page, vendor partners that provide support for programs such as state dual eligibility, and/or a member summary document) as well as through various messaging channels (e.g., fax, e-mail, postal mail, text/SMS, live calls, etc.).

The RGX business rules process 114 supports automation in a wide variety of clinical business processes such as utilization management, case management, clinical messaging, program eligibility, and workflow routing. The rules define clinical policies and business rules for authorization approval, automated queue routing based on intervention programs, clinical condition identification, stratification, and routing, and may further support predictive modeling processes, clinical notes, tasks, and alert generation, clinical messaging generation, aggregation, and routing and care alert generation. The use of a rules-based process provides flexibility to support rapidly changing and emerging business needs in the area of clinical actions and support. The routing of authorizations for various actions may be controlled based on qualification criteria in the form of rules for each clinical intervention. Additionally, rules to prioritize activities may be applied in the event multiple signals or calls to action are triggered.

In an example embodiment, the CGX 104 comprises a member profile process 106 that receives member data from the clinical data hub 118 and the rules-based engine 110 and generates and stores in a clinical profile database an integrated member profile 106 comprising the member's health condition data, care gaps and quality alerts, a 90-day health history summary, risk scores, and a utilization summary. Access to the integrated member profile data is controlled through workflow applications 108 that support the diverse user community. Each user group 102 interacts with the CGX 104 though a workflow process designed to meet the needs of the group. Each user group is provided with access to member data that is most relevant to their responsibilities. An integrated medical record viewer 120 provides users with access to healthcare provider medical records accessible through the clinical data hub 118.

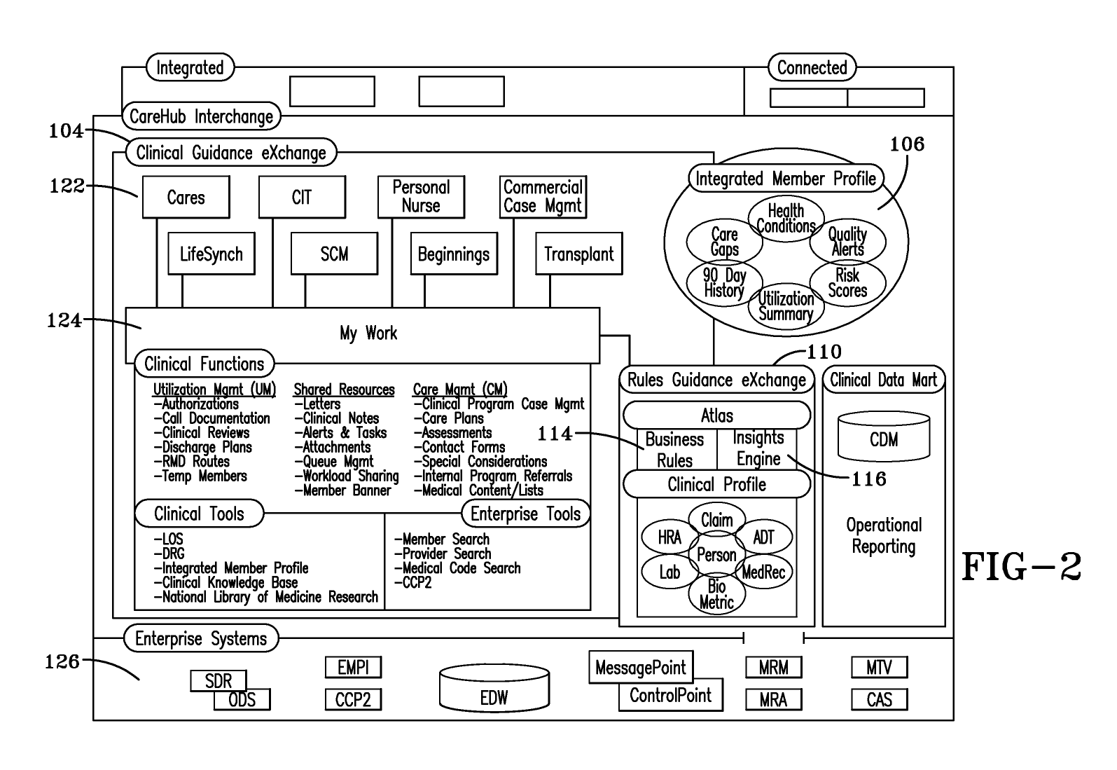

Referring to FIG. 2, a CGX workflow details diagram according to an example embodiment is shown. In an example embodiment, the CGX 104 supports a plurality of user groups 122 that assist members of a health benefits plan in a variety of ways. Groups may provide clinical intake services, senior care services home health assessments, improved lifestyle support services, mental health services, personal nurse services, new mother and infant services, commercial case management services, services for transplant patients, triage nurse services, disease management services, etc. Each user group is supported by a clinical workflow application 124 that accesses an integrated member profile 106 and RGX 110 to facilitate identification of candidates for various clinical actions, interventions, alerts, programs, etc. The CGX 104 comprises a plurality of clinical functions and clinical tools as well as enterprise tools that provide access to enterprise systems 126 operated by the health benefits company. The enterprise systems may provide functionality such as generating communications for members that are relevant to their health conditions and that identify appropriate clinical actions. The enterprise systems further transmit the member communications through various communication channels such as member web portals, email messages, telephone messages, and direct mail.

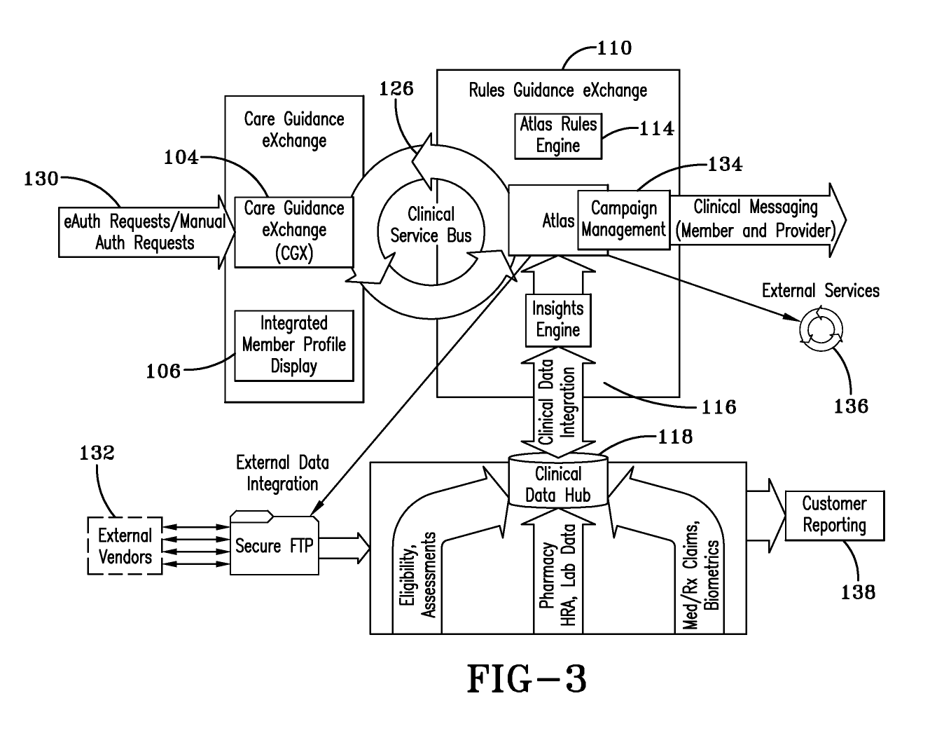

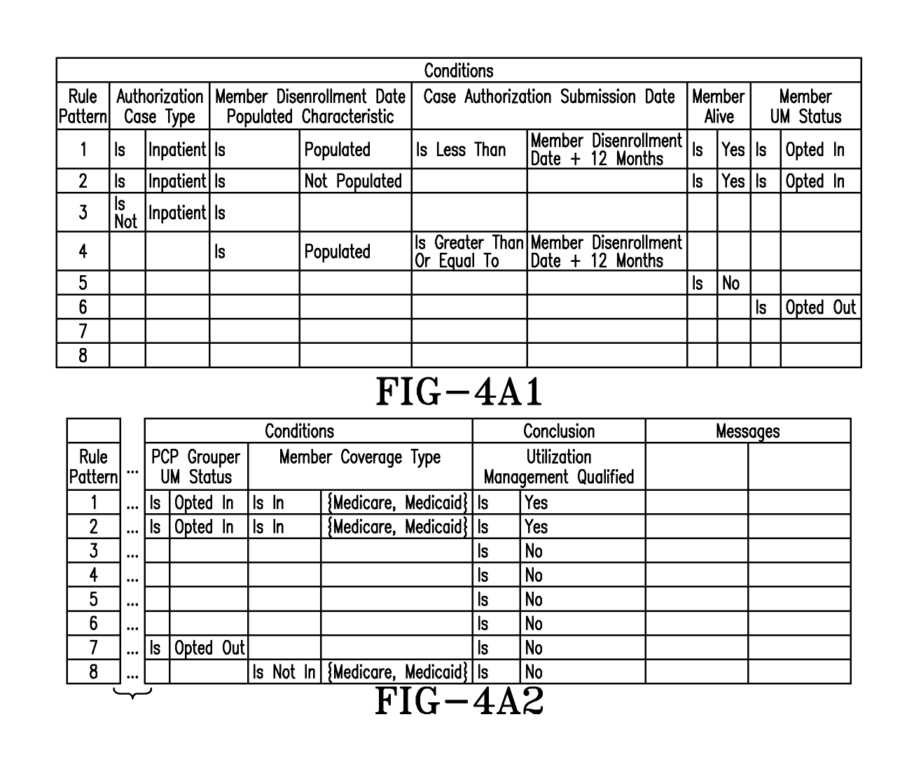

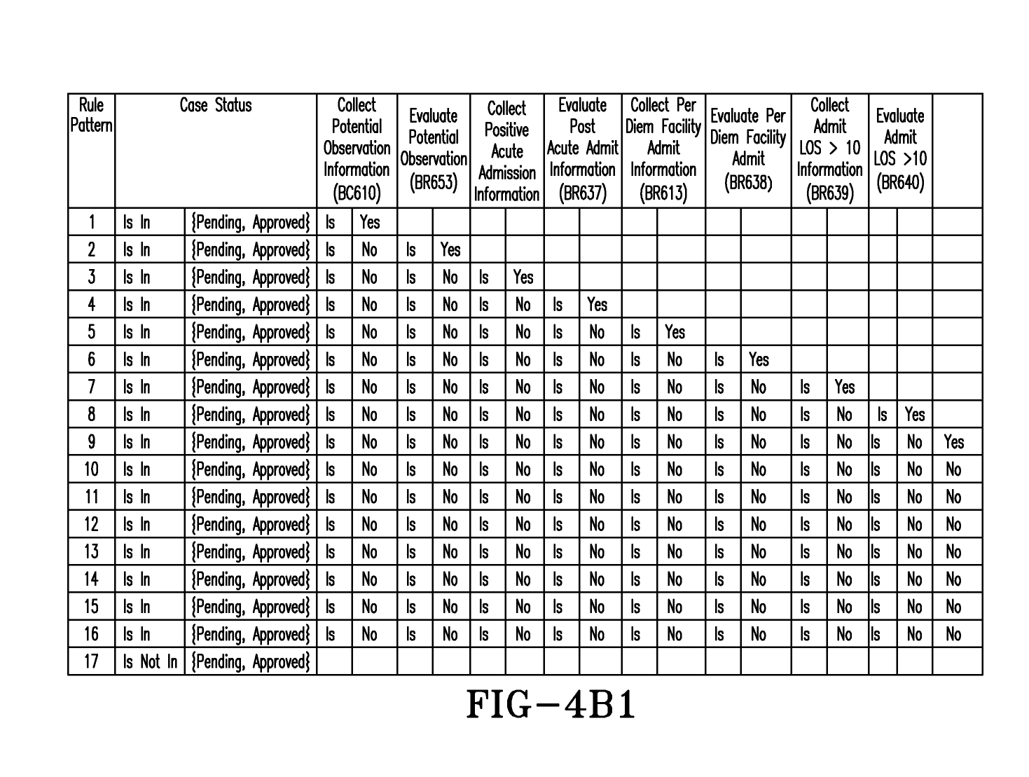

Referring to FIG. 3, a data flow diagram for a CGX 104 according to an example embodiment is shown. Users interacting with workflow applications initiate requests (e.g., automated or manual authorization requests) 130 that are serviced by the CGX 104 using integrated member profile data 106 and a RGX 110. Each workflow application is designed to meet the needs of multiple user groups. Workflow applications may provide the following functionality.

TABLE 1
Workflow Functionality

| User Group | Workflow Requests |
|---|---|
| Member | My Work workflow management of automated referrals |
| Care/Case | to clinical programs |
| Management | Nurse referrals of members to internal programs; |
| 130 | Various applicable health risk scores to determine |
| | potential complex chronic membership and proactively |
| | reach out |
| | Clinical Program Case Management (CP CM) cases for |
| | management of a member within a clinical program |
| | Assessments to evaluate a member's health conditions |
| | and identify opportunities for improvement, |
| | including external care plans and assessments being |
| | managed by vended partners |
| | Care Plan to manage a member's problems, goals, and |
| | clinician Interventions |
| | Documentation of all contact with members and |
| | providers and the outcome of the call |
| | Manage lists of medications, allergies, and |
| | immunizations for a member |
| | Post-Discharge Care Coordination, including an |
| | integrated member profile |
| Utilization | Electronic authorization |
| Management | Manually entered authorization |
| 130 | Authorization management including decision support |
| | and workflow processes and including question/answer |
| | driven authorization determination |
| | Automation of electronic authorizations via other |
| | systems |
| | MyWork workflow management of authorizations via |
| | queues and filters |
| | Documentation of clinical reviews for level of care |
| | and authorization status determination (including |
| | creation of case notes, tasks for follow-up, and |
| | attachment of a member's clinicals) |
| | Regional medical director workflow and documentation, |
| | including consultation documentation between nurses, |
| | clinical leaders and doctors |
| | Letter templates and fulfillment automation for |
| | approval/denial letters as well as other letters |
| | generated to both members, providers/caregivers |

As requests are received at the CGX 104 from workflow applications, CGX 104 engages a clinical service bus 126 to locate rules from the RGX 110 that are relevant to the request. Business rules 114 support the identification, evaluation, decisioning, and routing processes. Identification rules indicate what signals are needed to trigger an evaluation process according to the clinical rules 116. Automatically generated signals may include medical claims (e.g., paid, pended and rejected), pharmacy claims, laboratory results, authorizations, market-specific requirements, and referrals. Manually generated signals may include transition of care activities, health risk assessments, specialized programs and activities (e.g., nurse triage service, senior care case management, disease management, personal nurse, transplant, new mother and infant, etc.), and customer contact calls.

Evaluation rules define what action should take place based on the interpretation of a signal or signals and member specific data residing in the integrated member profile 106. Actions may include the automatic generation of an intervention referral (internal or external), the automatic generation of a claim data extract for transmission to an intervention vendor (external), the automatic generation of a reminder in the form of a secured message sent to a member, and the automatic generation of alerts and notifications related to members that are routed to intervention areas already involved with a member.

Routing rules define the parameters that are used in the delivery of the resulting action or actions of the evaluation process. The parameters may include parameters for timing or scheduling of the delivery and how the delivery is made (e.g., web transactions, FTP, FAX, telephone, etc.). 4A1, 4A2, 4B1, 4B2, and 4C are tables illustrating rules processing by a RGX according to an example embodiment. The tables illustrate identification, evaluation, and routing for converting inpatient authorizations that are best served as observation stays.

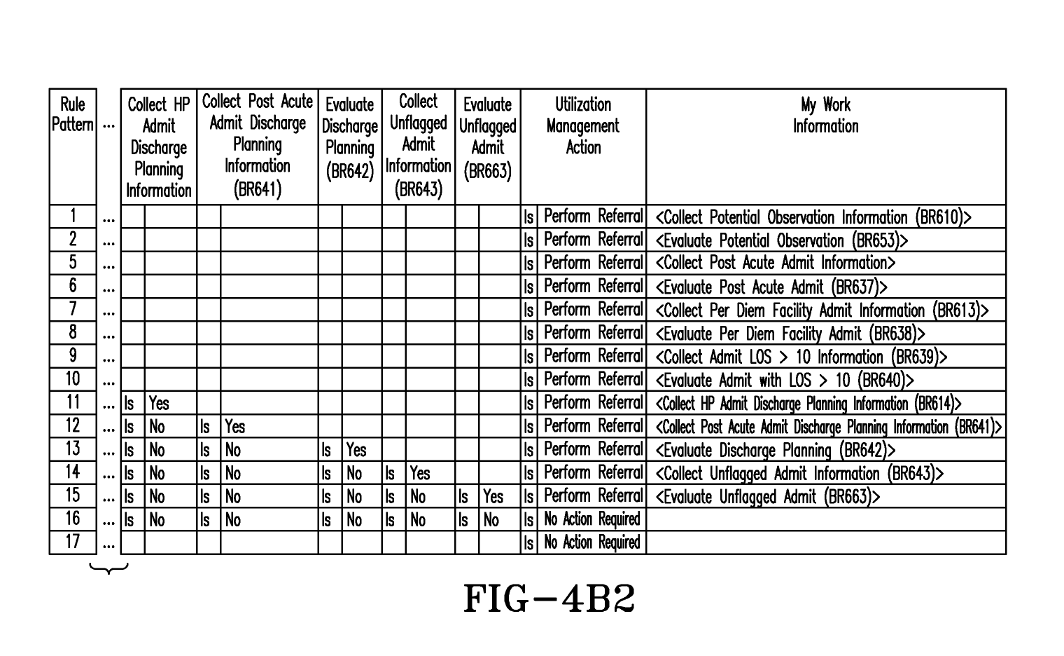

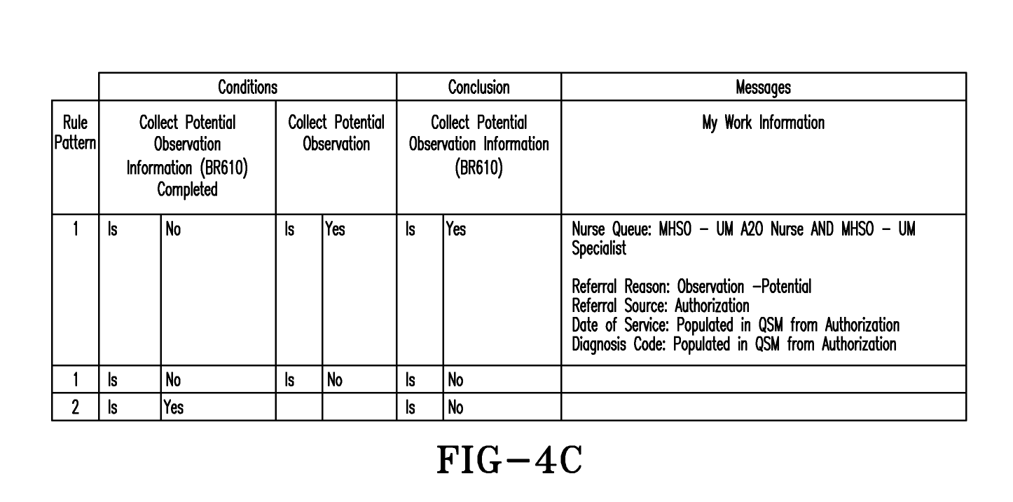

FIGS. 4A1-4A2 illustrate rules for identifying members eligible for utilization management services. Inpatient hospital authorizations are processed. In particular, a plurality of conditions shown in the columns of FIGS. 4A1-4A2 are evaluated such as the “authorization case type,” whether a “member disenrollment date” field is populated, how the case authorization submission date relates to the member disenrollment date, and other utilization management parameters. The rules are applied to member data to reach a conclusion regarding utilization management as shown in FIG. 4A2.

FIGS. 4B1-4B2 illustrate rules for utilization management eligible members that are evaluated to determine the types of interventions for which the member qualifies and the appropriate routing for the member. As indicated in FIGS. 4B1-4B2 observation data, acute admission data, per diem facility admission data, length of stay, discharge data, and other parameters are collected and evaluated. Following application of the rules, a utilization management action is determined as shown in FIG. 4B2 and a work information action is set.

FIG. 4C illustrates routing rules. Relevant data points (e.g., CGX queue, referral reason, referral source, date of service, and diagnosis) are delivered to a utilization management nurse to perform various workflow actions for the member. Data from the databases 106 is accessed according to the relevant rules. Data from the integrated member profile may be displayed for the user to facilitate the user's interaction with the member or to facilitate advising the member on clinical actions. The RGX 110 may access one or more external data sources. A clinical rules process 116 may access a clinical data hub 118 to provide input to a clinical rules engine that generates various types of clinical actions such as health alerts. The clinical data hub may further access external resources 132 (e.g., laboratory results or pharmacy data from a third party vendor) to obtain additional data relevant to the request. A campaign management component 134 supports clinical messaging for actions to members and providers. Campaigns may be initiated throughout the year to inform members about services and programs that may be of interest based on their health status and clinical needs.

The RGX 110 identifies members for actions by accessing and analyzing data from a plurality of sources, many of which are accessible through a clinical data hub 118. A member's demographic data, medical, pharmacy, and laboratory claims data as well as prior authorizations, referrals data, and external vendor care plans and/or assessments may be analyzed to identify a member's clinical conditions. Members may also self-report information through a health risk assessment, nurse assessment, or other instrument. Predictive models may be applied to member data to identify members at risk for various health conditions. Predictive model scores may be used to stratify member populations for actions directed to specific health conditions. A clinical intervention appropriateness (CIA) score and/or claims based algorithm (CBA) score may also be calculated and considered in selecting candidates for interventions. One or more profile flags may be set in a member's profile to further facilitate identification of candidates for actions. Additional factors that may be considered are major clinical or chronic care needs categories, prior intervention program participation information, utilization information, contact results from customer service calls, web-site visits, secured messages, and VAT calls, needs recognized through transition of care information, information derived from test and laboratory results, and information gathered during initial contact calls with members. A member's data from a variety of sources may be stored in an integrated member profile to facilitate the identification of clinical conditions and appropriate actions.

A customer profile identifies the actions, alerts, interventions, and/or programs each customer selects for its employees or sponsored participants. The customer profile data may be used to establish business rules that are applied by the RGX as members are identified for action.

A clinical action profile defines the clinical actions such as health alerts, clinical interventions, and/or programs that are supported by the health benefit plan providers. Additional details in the clinical action profile include programs and campaigns that may be offered to qualifying members to educate them about the actions and interventions and to encourage them to respond or participate. The clinical action profile further identifies the administrator (e.g., internal or vended), the cost of the actions, and the business segments that are eligible. The clinical action profile may also comprise information for exclusions (e.g., based on provider group, enterprise, customer, and subgroup levels, product, segment, platform, market, current participation, and member request).

In an example embodiment, the CGX 104 uses profile data and business and clinical rules from the RGX 106 and 114 to identify candidates for clinical actions. Criteria may be established to stratify and rank action candidates by assigning a numeric value to each medical condition used in a stratification process. A total score may be calculated for each candidate by tallying the scores associated with each candidate's medical conditions. The candidates may then be ranked from highest score to lowest score. Rules and stratification parameters may be updated and applied quickly to meet the needs of the businesses.

The CGX 104 may select candidates for actions based on each candidate's stratification score and pre-determined business defined threshold levels that are stored with other evaluation rules. Thresholds may be varied based on market and quickly modified based on changing business needs. The thresholds may have the following characteristics:
4. The thresholds may be set by either specifying an absolute number of referrals (i.e., the ‘x-number’ candidates with the highest score) or by specifying a target score (i.e., any candidate with a score over ‘###’);
5. Separate thresholds may be set for administrative services only (ASO) and fully insured candidates; and
6. Fully insured thresholds may be separated into thresholds for commercial and non-commercial candidates.

Customer reporting features 138 are also supported by the clinical data hub 118.

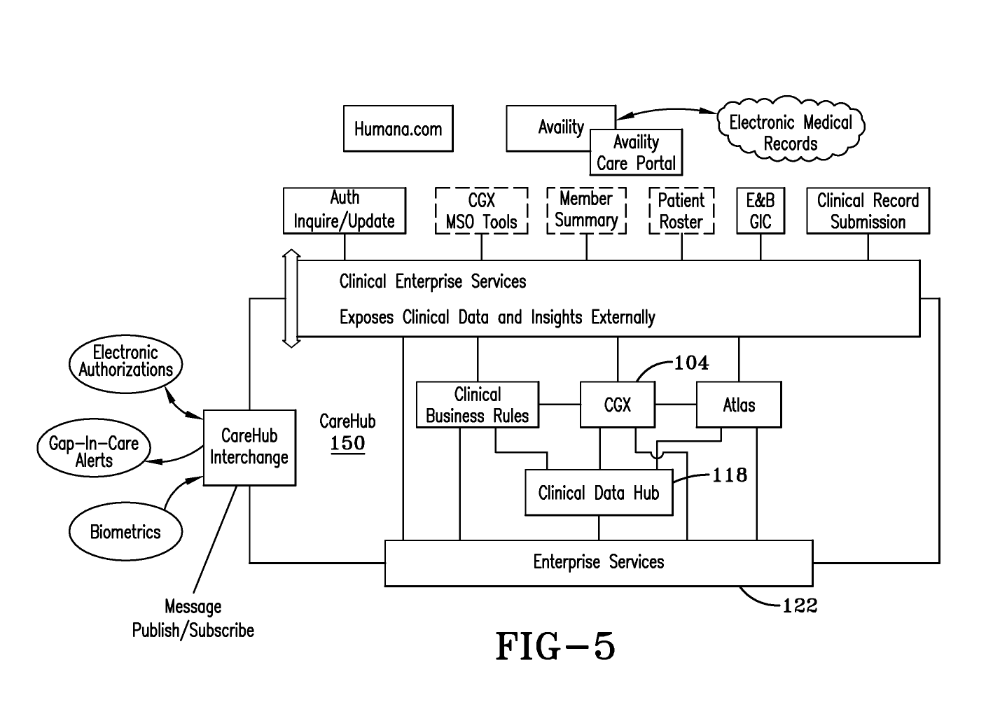

Referring to FIG. 5, a provider connectivity diagram according to an example embodiment is shown. As indicated in FIG. 5, healthcare provider communication may be facilitated through a “carehub” 150 comprising the CGX 104 and other components that support clinical actions.

Having shown and described a preferred embodiment of the present invention, those skilled in the art will realize that many variations and modifications may be made to the described invention and still be within the scope of the claimed invention. Many of the elements indicated above may be altered or replaced by different elements that provide the same or substantially the same result and fall within the spirit of the claimed invention. Various aspects or elements of the integrated member profile and the business and clinical rules may be varied and fall within the scope of the claimed invention. Various aspects of the candidate identification process for clinical actions may change and fall within the scope of the claimed invention. The types and nature of the communications regarding clinical actions may be changed and fall within the spirit of the claimed invention. Therefore, as can be understood from a review of the foregoing description and accompanying drawing figures, the computerized system and method supports clinical actions for members of health benefit plans to improve outcomes. Consequently, while certain exemplary embodiments of the present invention are described in detail above, the scope of the invention is not to be considered limited by such disclosure, and modifications are possible without departing from the spirit of the invention as evidenced by the following claims:

1. A computerized method to identify a subset of members for a clinical action comprising one or more computers executing programming instructions to:
(a) store in a member profile database member profile data for members of a health benefit plan, said member profile data comprising for each member:
(i) identifying data for said member; and
(ii) health condition data;
(b) store in a clinical rules database clinical rules data for a plurality of clinical actions, said clinical rules data comprising health condition data for each clinical action;
(c) store in a business rules database business rules which:
(i) identify the subset of members to be evaluated for clinical actions according to evaluation triggers;
(ii) evaluate the subset of members for clinical actions using said clinical rules data; and
(iii) route communications for clinical actions;
(d) receive a workflow request, said workflow request comprising identifying data for a member of said health benefit plan and at least one evaluation trigger;
(e) apply a first business rule from said business rules database to said evaluation trigger where said first business rule identifies a plurality of clinical functions and tools applicable to said member according to said evaluation trigger;
(f) access from said member profile database member profile data for said member;
(g) apply a second business rule and at least one clinical rule to said member profile data to select a routing method for a clinical action communication;
(h) generate a clinical action communication as the result of the application of said at least one clinical rule; and
(i) route said clinic action communication from said one or more computers according to said routing method.

2. The computerized method of claim 1 wherein said evaluation triggers are selected from the group consisting of: automatically generated triggers and manually generated triggers.

3. The computerized method of claim 2 wherein said automatically generated triggers are generated upon the receipt of one or more of the following: paid medical claims, pended medical claims, rejected medical claims, pharmacy claims, laboratory results, authorizations, and referrals.

4. The computerized method of claim 2 wherein said manually generated triggers are generated upon the detection of one or more of the following events: transition of care activities, health risk assessments, nurse triage service, senior care case management, disease management programs, personal nurse programs, transplant programs, new mother and infant programs, and customer contact calls.

5. The computerized method of claim 1 wherein said clinical actions communications are selected from the group consisting of internal intervention referrals, external intervention referrals, claim data transmission to an intervention vendor, member reminder, and alerts and notifications.

6. The computerized method of claim 1 wherein said clinical actions communications are directed to persons selected from the group consisting of members, caregivers, physicians, and clinicians.

7. The computerized method of claim 1 wherein said routing method is selected from the group consisting of web portal transactions, email messages, FTP data transfers, fax communications, telephone communications, and direct mail.

8. A computerized system to identify a subset of members for a clinical action comprising:
(a) a member profile database storing member profile data for members of a health benefit plan, said member profile data comprising for each member:
(i) identifying data for said member; and
(ii) health condition data;
(b) a clinical rules database storing clinical rules data for a plurality of clinical actions, said clinical rules data comprising health condition data for each clinical action;
(c) a business rules database storing business rules to:
(i) identify the subset of members to be evaluated for clinical actions according to evaluation triggers;
(ii) evaluate the subset of members for clinical actions using said clinical rules data; and
(iii) route communications for clinical actions;
(d) one or more computers executing programming instructions to:
(i) receive a workflow request, said workflow request comprising identifying data for a member of said health benefit plan and at least one evaluation trigger where said first business rule identifies a plurality of clinical functions and tools applicable to said member according to said evaluation trigger;
(ii) apply a first business rule from said business rules database to said evaluation trigger;
(iii) access from said member profile database member profile data for said member;
(iv) apply a second business rule and at least one clinical rule to said member profile data to select a routing method for a clinical action communication;
(v) generate a clinical action communication as the result of the application of said at least one clinical rule; and
(vi) route said clinic action communication from said one or more computers according to said routing method.

9. The computerized system of claim 8 wherein said evaluation triggers are selected from the group consisting of:
automatically generated signals and manually generated signals.

10. The computerized system of claim 9 wherein said automatically generated triggers are generated upon the receipt of one or more of the following: paid medical claims, pended medical claims, rejected medical claims, pharmacy claims, laboratory results, authorizations, and referrals.

11. The computerized system of claim 9 wherein said manually generated triggers are generated upon the detection of one or more of the following events: from transition of care activities, health risk assessments, nurse triage service, senior care case management, disease management programs, personal nurse programs, transplant programs, new mother and infant programs, and customer contact calls.

12. The computerized system of claim 8 wherein said clinical actions communications are selected from the group consisting of internal intervention referrals, external intervention referrals, claim data transmission to an intervention vendor, member reminder, and alerts and notifications.

13. The computerized system of claim 8 wherein said clinical actions communications are directed to persons selected from the group consisting of members, caregivers, physicians, and clinicians.

14. The computerized system of claim 8 wherein said routing method is selected from the group consisting of web portal transactions, email messages, FTP data transfers, fax communications, telephone communications, and direct mail.

15. A computerized method to identify a subset of members for a clinical action comprising one or more computers executing programming instructions to:
(a) generate customized member profiles for a plurality of members, said member profiles comprising medical and clinical data received from a plurality of member data sources;
(b) apply to said customized member profiles a plurality of clinical rules to identify for each member at least one health condition;
(c) set in each of said customized member profiles an action flag identifying said health condition;
(d) receive from a workflow application a request to access at least one of said customized member profiles;
(e) using said action flag, select for a member identified in said at least one of said customized member profiles a clinical action related to said at least one health condition; and
(f) generate for a computer user of said workflow application at least one alert for said clinical action related to said at least one health condition.

16. The computerized method of claim 15 wherein said customized member profile comprising member health condition data, health care gaps, health care quality alerts, a health history summary, a health risk score, and a utilization summary.

17. The computerized method of claim 15 wherein said workflow application is selected from the group consisting of:
member care management applications and health care utilization applications.

18. The computerized method of claim 15 wherein said instruction to set in each of said customized member profiles an action flag comprises an instruction to score and stratify said plurality of members into a plurality of groups.

19. The computerized method of claim 15 wherein said clinical action is selected from the group consisting of health alerts, clinical interventions, and health programs supported by a health benefits provider.

20. The computerized method of claim 15 wherein said clinical action is selected from a clinical action profile identifying an administrator, a cost for said clinical action, a business segment eligible for said clinical action, and exclusions for said clinical action.
